(19) United States
(12) Patent Application Publication
(10) Pub. No.: US 2009/0044200 A1
(43) Pub. Date: Feb. 12, 2009

(54) METHOD AND SYSTEM FOR ASYNCHRONOUS THREAD RESPONSE DETECTION IN AN ELECTRONIC COMMUNICATION SYSTEM

(76) Inventors: Aakash Bordia, San Jose, CA (US); Michael R. O'Brien, Westford, MA (US); A. Julie Kadashevich, Tyngsboro, MA (US)

Correspondence Address: LOTUS AND RATIONAL SOFTWARE;David A. Dagg, Esq., 44 Chapin Road, Newton, MA, 02459, US

(21) Appl. No.: 11/837,500

(22) Filed: Aug. 11, 2007

(51) Int. Cl. G06F 3/00

(52) U.S. Cl. 719/314

(57) ABSTRACT

A system for asynchronous thread response detection in an electronic communication system. Alert messages are provided to a user who is in the process of responding to a message in a message thread. The alert messages are provided when there are new messages in the thread, including messages in thread that were received before the user started responding, and/or messages that were received while the user was composing the response. The disclosed system is advantageous in that it the responding user does not necessarily have to manually check for new thread messages prior to or while they are composing a response to a message within the thread.

### FIELD OF THE INVENTION

The present invention relates generally to computer based communication and collaboration applications, and more specifically to a method and system for asynchronous thread response detection in an electronic communication system.

### BACKGROUND OF THE INVENTION

Electronic mail (“e-mail”) is a widely used example of a contemporary electronic communication system. E-mail systems operate by transmitting text messages and optional file attachments over a communication network. An e-mail user can send an e-mail message to a single recipient or broadcast it to multiple users.

E-mail messages are typically stored in a network mail server until they are downloaded into client systems and read by their recipient users. An e-mail system uses a messaging system to provide its store and forward capability, such as the Internet's Simple Mail Transfer Protocol (SMTP). The e-mail client provides a user interface with send and receive functions. Alternatively, a Web browser can also substitute for the e-mail client program, e.g. when an Internet e-mail service is used.

In existing systems, an e-mail client program periodically queries the e-mail server for new messages on a continuous basis (e.g. every few minutes), and may provide a generic “new mail” indication (e.g. by displaying an envelope icon or the like) to the local user whenever it detects that one or more new messages have been received and but have not yet been read by the local user.

Problems arise in existing systems when a user composes a reply to a message sent to multiple recipients. This situation occurs often, since e-mail messages are frequently sent to multiple recipients using a distribution list, group addresses or multiple e-mail addresses. Such multiple recipient e-mail messages may be used to start or contribute to a multi-user, on-line discussion conducted through a series of e-mail messages that are responses based on an initial message. The messages making up such a discussion are referred to as a message “thread” that includes the initial message and all subsequent replies based on the initial message (including replies to replies). In the context of a message thread involving more than two users, there a significant possibility that multiple users will compose a response to one or more thread messages at the same time. In this situation, some problematic scenarios include the following:

1) Multiple recipients attempt to respond in overlapping time periods, with different or possibly the same semantic content.

2) Multiple recipients attempt to respond in non-overlapping time periods, with possibly the same or different semantic content, but without reading the other responses.

In both cases, problems may result including time wasted and productivity lost on part of the responder(s), an overload of unneeded messages, time wasted and productivity lost on the part of message recipients, and increased consumption of network bandwidth that could be avoided. Moreover, similar problems can arise even when only two users are simultaneously sending messages to each other. These shortcomings of existing systems especially apply in situations where only a few responses could have ended a message thread.

Existing systems are able to inform a responder if another user is composing a response within the thread, but do not indicate when that response is sent by the other user. In this way existing systems provide an indication similar to the “typing” status provided by existing instant messaging software. In addition, existing systems can organize messages within a message thread, so that a user that is not currently composing a message can determine if there are unread messages in the thread. However, existing systems do not specifically alert a user that a new thread message has been received, or that there exist unread messages in the thread, while the user is composing a response to be entered into the thread. This problem is not addressed by the generic “new mail” icon provided in some existing systems, since that indication does not distinguish between new messages within a thread being responded to and all other received messages, and accordingly does not provide a separate, distinct indication when such new thread messages are available and/or received while the user is composing a response to a message in the thread.

For these reasons and others it would be desirable to have a new method and system for asynchronous thread response detection in an electronic communication system. The system should advantageously alert thread message recipients with regard to thread messages received or unread while they are composing a response to be entered into the thread. Upon receiving such an alert, the responding user can potentially change the contents of their response, or avoid responding altogether.

### SUMMARY OF THE INVENTION

To address the above described and other shortcomings of previous solutions, a new method and system are disclosed for asynchronous thread response detection in an electronic communication system. In the disclosed system, alert messages are provided to a user who is in the process of responding to a message in a message thread. The alert messages of the disclosed system are provided when there are new messages in the thread, including messages in the thread that were received before the user started responding, and/or messages that are received while the user is composing the response. The disclosed system is advantageous in that the responding user does not have to manually check for new thread messages prior to or while they compose a response to a message within the thread.

The disclosed system operates by detecting when the user starts responding to a message contained in a message thread, and by then asynchronously checking in the e-mail client and/or with the e-mail server to determine if there are unread thread responses in the client system or newly received thread responses in the server system. In the event such unread and/or newly received responses are identified, the system alerts the user with an alert message, e.g. pop-up window, sound, etc., potentially based on the user's configured preferences. The alert message may specifically identify and/or provide links to the message thread and/or identified unread and/or newly received thread responses.

In the event that the user attempts to send the response before the server has responded regarding any newly received thread messages, the system may be embodied or configured to continue to wait for the server to respond before transmitting the response. If the system wait until the server responds, the system alerts the user if the response indicates one or more newly received thread messages were identified on the server system and have been downloaded to the client system since the user started responding. Alternatively, the disclosed system may be embodied or configured to allow the user's response to be transmitted without receipt of the server's response in the event the server has not responded when the user completes their response.

Thus there is disclosed a new method and system for asynchronous thread response detection in an electronic communication system. The disclosed system advantageously alerts thread message recipients with regard to thread messages that are received and/or unread while they are composing a response to be entered into the thread. Upon receiving such an alert, the responding user can potentially change the contents of their response, or avoid responding altogether.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components in an illustrative embodiment of the disclosed system; and

FIG. 2 is a flow chart showing steps performed in an illustrative embodiment of the disclosed system.

### DETAILED DESCRIPTION OF EXEMPLARY EMBODIMENTS

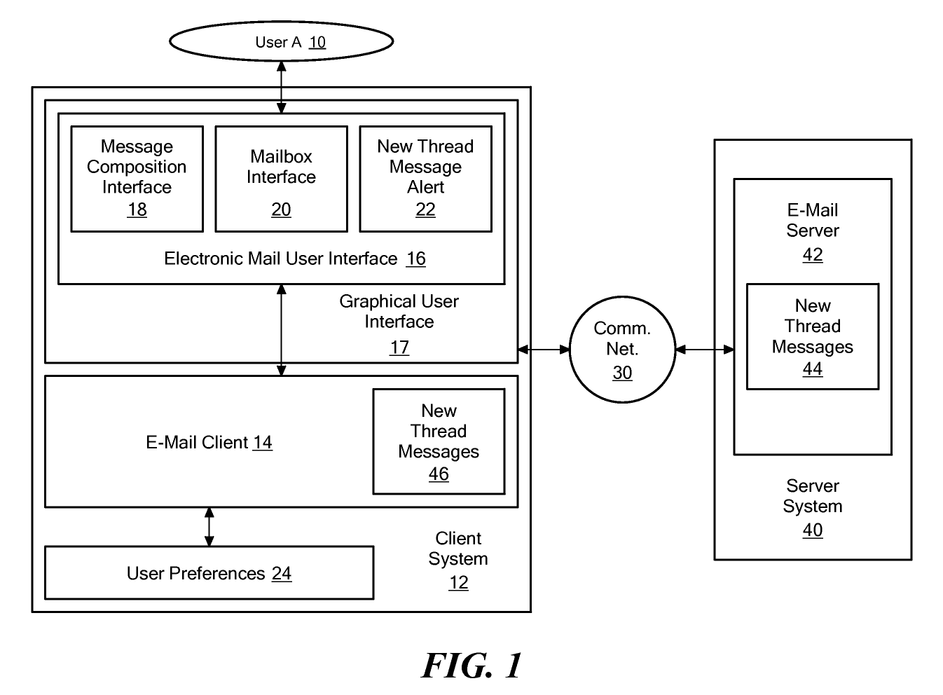

As shown in FIG. 1, the disclosed system provides a User A 10 of a Client System 12 is with an E-Mail User Interface 16 contained in a Graphical User Interface 17. The E-Mail User Interface 16 is generated by an E-Mail Client 14, and is shown including a Message Composition Interface 18, a Mailbox Interface 20, and a New Thread Message Alert 22. The E-Mail Client 14 operates in response to a number of User Preferences 24 indicating how User A 10 has configured the operation of the E-mail Client 14. The E-Mail Client 14 communicates via Communication Network 30 with E-Mail Server 42 on remote Server System 40. As described further below, the E-Mail Client 14 operates to determine whether any new messages are available in a message thread while User A 10 is responding (e.g. composing a response) to a message in that thread. Such new messages for a thread are shown for purposes of illustration by New Thread Messages 44 in the E-Mail Server 42, and by New Thread Messages 46 in the E-Mail Client 14. The New Thread Messages 44 and/or New Thread Messages 46 may include messages in the thread that were received by the Client System 12 and/or Server System 40 prior to the time that User A 10 started to reply to a message in the message thread, but that were unread by User A 10 at that time, and/or messages in the thread that were received by either the Client System 12 and/or Server System 40 after the time that User A 10 started to reply to the message in the messages thread.

For example, the Mailbox Interface 20 may display a list of messages to User A 10, such as a list of messages previously retrieved by the E-Mail Client 14 from the E-Mail Server 42 (e.g. as stored in an “Inbox” mailbox for User A 10). When User A 10 selects one of the messages listed in the Mailbox Interface 20 (e.g. by clicking on a list entry representing that message within the Mailbox Interface 20), and then begins to reply to that selected message (e.g. by clicking on a “Reply” user interface button or the like), this event causes the disclosed system to begin determining whether there are any new messages in the message thread to which the response message will be added. For example, in response to User A 10 clicking on a “Reply” button or the like, the E-Mail Client 14 may check for any unread messages in the thread (e.g. thread messages not yet opened by User A 10) that are stored on the Client System 12 (e.g. New Thread Messages 46), and/or any messages in the thread received by the E-Mail Server 42 but not yet transferred to the Client System 12 (e.g. New Thread Messages 44). In the event that one or more such new messages are found, the E-Mail Client 14 generates the New Thread Message Alert 22. The New Thread Message Alert 22 may be any specific type of alert, and in one embodiment the specific type of alert is determined by the E-Mail Client 14 based on the contents of the User Preferences 24. The User Preferences 24 may include configuration settings provided by the User A 10 through the Electronic Mail User Interface 16.

For example, the New Thread Message Alert 22 may be a pop-up window or other specific type of display object displayed within a multi-window graphical user interface or the like. In one embodiment, the New Thread Message Alert 22 displays the identity of and/or other information regarding the message thread into which the response is being entered (e.g. by displaying the subject of the message thread and/or other thread identification information), includes a list of links to all new messages existing within the message thread, and may further indicate specific information regarding each identified new thread message, such as, for example, the sender of the message, the time the message was received, etc.

While for purposes of concise illustration only one user (User A 10) is shown in FIG. 1, those skilled in the art will recognize that the disclosed system may be embodied such that any specific number of users may be supported. Similarly, while only one client system (Client System 12) and one server system (Server System 40) are shown in FIG. 1, the disclosed system may be embodied to operate on any specific number of client and/or server systems.

The Client System 12 of FIG. 1 may be any specific type of a computer system or intelligent electronic device, such as a desktop, laptop, or palmtop computer system, or a personal digital assistant, cell phone, or other electronic device. The Client System 12 includes or controls a display device capable of displaying the Graphical User Interface 17 to the local User A 10, such as a liquid crystal display (LCD), cathode ray tube (CRT), interferometric modulator display (IMOD), light emitting diode (LED), or the like.

Those skilled in the art will recognize that the E-Mail Client 14 and E-Mail Server 42 may be embodied using software or firmware, such as computer application program code, operating system program code, middleware, and/or wholly or partly using digital hardware components, such as application specific integrated circuits (ASICs), field-programmable gate arrays (FPGAs), and the like, and/or combinations of hardware and/or software or firmware. Those skilled in the art will further recognize that the Client System 12 and Server System 40, and/or any other client systems or server systems within the Communication Network 30, may include one or more processors, and program storage, such as memory, for storing program code executable on such processors, as well as input/output devices and/or interfaces. In the example of FIG. 1, the Client System 12 and Server System 40, are interconnected to a computer or data Communication Network 30 (e.g. the Internet, a Local Area Network, etc.) through one or more of such input/output devices or interfaces, and through which may further be provided communication to a number of other client systems and/or other server systems.

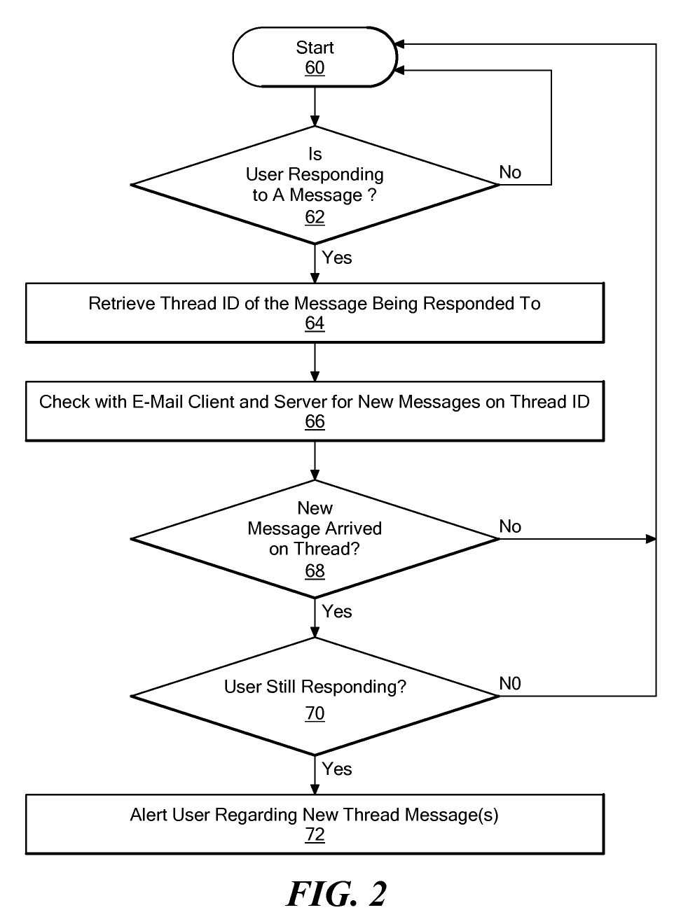

FIG. 2 is a flow chart showing steps performed during operation of an embodiment of the disclosed system. After the initial Start 60, at step 62 the disclosed system operates to determine or detect when the local user begins responding to and/or continues to be responding to a message. The determination of whether a user is responding to a message at step 62 may, for example, include detecting that the user has performed one or more pre-determined actions in the user interface to initiate the creation of a response message, such as, for example, clicking on a “Reply” button or the like in the graphical user when a received message is currently selected (e.g. within the Mailbox Interface 20 of FIG. 1). The detection of such a pre-determined user action by the disclosed system may further result in a message composition user interface display object being generated by the e-mail client (e.g. Message Composition Interface 18 of FIG. 1). Such a message composition user interface display object may, for example, include a text entry region or area into which the user can type or otherwise enter text (and that may also be pre-loaded with at least a portion of the previously selected message to which reply is being generated). The message composition user interface display object may further enable the user to attach one or more documents to the response, and provide user access to other features relevant to composing a response.

In addition, a determination at step 62 may include determining whether a user is continuing to respond to a message by checking as to whether a message composition interface (e.g. Message Composition Interface 18 of FIG. 1) is currently open.

The actions that may be detected at step 62 that indicate that a user has started or is continuing to respond to a message may include any and/or all activities related to responding to a message. Such activities may, for example, include composing a response message, sending a response message, opening a message to which a response may later be generated, etc.

In response to detecting at step 62 that the user is responding to a message, e.g. has initiated creation of a response to a message or is in some way continuing to respond to a message, step 62 is followed by step 64, in which the disclosed system identifies the message thread to which the response being composed will be added. For example, the disclosed system may operate at step 64 to determine a thread identifier of a message thread to which a previously selected message being responded to belongs. In general, a given message thread is made up of an original “root” message, and all child messages that are replies to either the root message or to subsequent replies. Messages within a message thread may share and/or include a common root message (e.g. initial message) of the thread, and/or share or include a common topic or subject that is defined in or by the root message of the thread. In one embodiment of the disclosed system, each message in the e-mail system is associated with a thread identifier for each thread to which it belongs.

Using the thread identifier obtained at step 64, at step 66 the embodiment of the disclosed system illustrated in FIG. 2 checks messages stored both on the client system on which the e-mail client is operating, and within the remote server system on which the mail server process operates, to determine whether there are any new messages for the thread identified by the thread identifier. For example, new thread messages may include messages within the thread that have previously (e.g. prior to the user beginning to reply to a message in the thread) been obtained from the e-mail server, and that are currently stored in the client system. New thread messages identified at step 66 may alternatively or additionally include messages within the thread that have not previously been moved from the e-mail server to the client system. Such new thread messages identified on the server system at step 66 may also be downloaded to the client system at step 66 for access by the client system user. In this way, the disclosed system identifies any new thread messages in either the client system or the server system at step 66, and downloads such new thread messages from the server system as needed.

At step 68, the disclosed system operates to determine whether the number of new thread messages identified in step 66 is non-zero (i.e. one or more new thread messages were found in the client and/or server system). If yes, then step 68 is followed by step 70, in which the disclosed system determines if the user is still composing the response message to be added to the thread. Otherwise, the process of FIG. 2 is repeated (e.g. periodically while the user is composing the response), and accordingly step 68 is followed by the start 60 of the flow.

At step 70, the disclosed system may operate to determine if the user is no longer responding by, for example, determining if the user has clicked on a “Send” button or the like in the user interface, thereby attempting to cause the response message to be transmitted, or has clicked on an “Exit” or “Cancel” button or the like, thereby causing the response message to be cancelled without being sent. If such a user action has not been detected, then the message composition user interface for the reply message being created is still open, and the user is still responding (e.g. composing the response in the message composition user interface). In the case where the user is determined to be still responding, step 70 is followed by step 72, in which the disclosed system generates an alert to the user indicating that there are one or more new messages in the thread to which they are responding. This enables the user to examine such new messages before the user completes and/or sends the response they are currently creating. Otherwise, if the user is determined to no longer be responding at step 70 (e.g. has previously clicked “Send” or “Exit”), then step 70 is followed by start 60 of the flow to wait until the user again begins replying to a message.

The activities checked at step 70 to determine whether the user is still responding may be the same set of the user activities that are detected at step 62 to determine that a user is responding to a message (e.g. composing a response message, sending a response message, opening a message to which a response may later be generated, etc.). Accordingly, if a user activity is detected at step 62 indicating that the user is responding to a message, and the user is still performing that activity at step 70, then step 70 will be followed by step 72.

In the event that the user attempts to send the response (e.g. clicks on “Send”) before the server has responded with regard to the presence or absence of any new thread messages, the disclosed system may be embodied or configured either to continue to wait for the server to respond, or to allow the user's response to be sent without receipt of the server's response regarding any new thread messages.

In addition, in another embodiment, in response to the user attempting to send a response, the disclosed system may be embodied or configured to perform a final check for new thread messages that have not been previously detected, prior to allowing the message to be sent. If any such new thread messages were detected in such a final check, a final alert message would then be issued to report such new thread messages prior to the response being sent, thus giving the user one final chance to change or cancel the response prior to it being sent, or to simply ignore (e.g. close) the alert message and allow the message to be sent without modification. However, if the server does not respond to the final check prior to expiration of a predetermined time limit, the disclosed system may be embodied or configured to allow the message to be sent without receipt of the server's response.

The alert generated at step 72 may be any specific kind of alert, such as a visual alert in the user interface (e.g. new pop-up window, new icon, etc.), and/or an audible alert (e.g. as defined in the user's system configuration), based for example on user preference settings associated with the e-mail client. For example, the alert generated at step 72 may be made up of a pop-up window including a list or links or other entries corresponding to the new thread messages and allowing the user to access (e.g. read) individual selected ones of the new thread messages prior to completing and/or sending the response.

In another aspect of the disclosed system, in response to the detection of one or more new thread messages stored on the remote server system at step 66, those detected new thread messages may be downloaded from the remote server system to the client system at step 72.

In one embodiment, the disclosed system continues to poll for new thread messages as long as the user is composing a response. The polling interval for checking the server and/or client system for new thread messages may be user defined, e.g. based on a user preference setting. In addition, polling for new thread messages in an embodiment of the disclosed system may be built upon more general polling of a server for all new messages received for the local user.

The disclosed system may be embodied such that multiple alert messages are generated to separately alert the user regarding different sets of new thread messages discovered while the user is responding to a message (e.g. while a user is composing a response to a thread message). In such an embodiment, in the event that a first alert is issued based on detection of a first set of one or more new thread messages, and then subsequently a second set of different new thread messages is detected before the user has completed the response or otherwise finished responding, then a second alert will be issued to bring the second set of new thread messages to the attention of the responding user. Similarly, any specific number of such additional alerts may be issued while the user continues to respond to the message, thus keeping the responding user promptly informed regarding all new thread messages while they are responding to the message.

While the above description regarding illustrative embodiments of the disclosed system includes examples of specific user interface display objects, such as graphical buttons, menus, dialog boxes, and the like, the present invention is not limited to those specific examples. Accordingly, those skilled in the art will recognize that alternative embodiments may use any specific type or kind of user interface display object that may be appropriate.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for asynchronous thread response detection in an electronic communication system, comprising:
detecting that a user is responding to a received message;
responsive to said detecting that said user is responding to said received message, identifying a message thread to which said received message belongs;
further responsive to said detecting that said user is responding to said received message, determining whether any new thread messages exist for said message thread; and
responsive to a determination that at least one new thread message exists for said message thread, generating an alert to said user notifying said user of said at least one new thread message.

2. The method of claim 1, wherein said detecting that said user is responding to a received message comprises detecting that said user has performed a predetermined action initiating a response to said received message.

3. The method of claim 2, wherein said predetermined action initiating said response to said received message comprises clicking on a button display object in a graphical user interface.

4. The method of claim 3, wherein said detecting that said user is responding to said received message further comprises detecting that said user is continuing to respond to said received message.

5. The method of claim 4, wherein said detecting that said user is continuing to respond to said received message comprises detecting that a message composition user interface is open.

6. The method of claim 1, wherein said identifying said message thread to which said received message belongs comprises determining a thread identifier associated with said received message.

7. The method of claim 1, wherein said identifying said message thread to which said received message belongs comprises determining a subject of said received message.

8. The method of claim 1, wherein said determining whether any new thread messages exist for said message thread further comprises determining whether at least one thread message is stored on a client system, wherein said thread message stored on said client system was not previously read by said user.

9. The method of claim 8, wherein said determining whether any new thread messages exist for said message thread further comprises determining whether at least one thread message is stored on a remote server system, wherein said thread message stored on said remote server system was not previously downloaded to said client system.

10. The method of claim 9, further comprising:
responsive to a determination that at least one thread message is stored on said remote server system and has not been previously downloaded to said client system, downloading said at least one thread message stored on said remote server system to said client system.

11. The method of claim 10, wherein said determining whether any new thread messages exist for said message thread is performed continuously while said user composes a response to said received message.

12. The method of claim 1, wherein said alert displays said message thread to which said received message belongs.

13. The method of claim 1, wherein said alert displays a link to said at least one new thread message.

14. The method of claim 1, wherein said generating said alert is responsive to at least one user preference indicating what type of alert is to be generated.

15. The method of claim 1, wherein said alert comprises a pop up window user interface display object.

16. The method of claim 1, further comprising:
detecting that said user has requested that a completed response message be added to said message thread;
responsive to said detecting that said user has requested that a completed response message be added to said message thread, determining whether a remote server system has responded to a request as to whether any new thread messages exist for said message thread; and
responsive to a determination that said remote server system has not responded to said request as to whether any new thread messages exist for said message thread, delaying transmission of said completed response message until said remote server system responds to said request.

17. A system including at least one processor and a computer readable for storing program code executable on said at least one processor, said computer readable medium having stored thereon program code for providing asynchronous thread response detection in an electronic communication system, said program code comprising:
instructions for detecting that a user is responding to a received message;
instructions for, responsive to said detecting that said user is responding to said received message, identifying a message thread to which said received message belongs;
instructions for, further responsive to said detecting that said user is responding to said received message, determining whether any new thread messages exist for said message thread; and
instructions for, responsive to a determination that at least one new thread message exists for said message thread, generating an alert to said user notifying said user of said at least one new thread message.

18. A computer program product including a computer readable for storing program code executable on at least one processor, said computer readable medium having stored thereon program code for providing asynchronous thread response detection in an electronic communication system, said program code comprising:
instructions for detecting that a user is responding to a received message;
instructions for, responsive to said detecting that said user is responding to said received message, identifying a message thread to which said received message belongs;
instructions for, further responsive to said detecting that said user is responding to said received message, determining whether any new thread messages exist for said message thread; and
instructions for, responsive to a determination that at least one new thread message exists for said message thread, generating an alert to said user notifying said user of said at least one new thread message.

19. A computer data signal embodied in a carrier wave, said computer data signal having program code encoded thereon for providing asynchronous thread response detection in an electronic communication system, said program code comprising:
instructions for detecting that a user is responding to a received message;
instructions for, responsive to said detecting that said user is responding to said received message, identifying a message thread to which said received message belongs;
instructions for, further responsive to said detecting that said user is responding to said received message, determining whether any new thread messages exist for said message thread; and
instructions for, responsive to a determination that at least one new thread message exists for said message thread, generating an alert to said user notifying said user of said at least one new thread message.

20. A system for providing asynchronous thread response detection in an electronic communication system, comprising:
means for detecting that a user is responding to a received message;
means for, responsive to said detecting that said user is responding to said received message, identifying a message thread to which said received message belongs;
means for, further responsive to said detecting that said user is responding to said received message, determining whether any new thread messages exist for said message thread; and
means for, responsive to a determination that at least one new thread message exists for said message thread, generating an alert to said user notifying said user of said at least one new thread message.
